(19) United States
(12) Patent Application Publication
(10) Pub. No.: US 2012/0071104 A1
(43) Pub. Date: Mar. 22, 2012

(54) TRANSMITTER DEVICE, RECEIVER DEVICE, AND WIRELESS COMMUNICATION SYSTEM

(76) Inventors: Takashi Onodera, Osaka (JP); Hiroshi Nakano, Osaka (JP); Kozue Hirata, Osaka (JP); Minoru Kubota, Osaka (JP)

(21) Appl. No.: 13/321,390

(22) PCT Filed: Apr. 14, 2010
(86) PCT No.: PCT/JP2010/056643

§ 371 Date: Nov. 18, 2011

(30) Foreign Application Priority Data
May 21, 2009 (JP) 2009-122915
Oct. 29, 2009 (JP) 2009-248452

(51) Int. Cl. H04B 15/00; H04B 1/10; H04B 1/04

(52) U.S. Cl. 455/63.1; 455/114.2; 455/296

(57) ABSTRACT

With respect to a wireless communication system comprising a transmitter device 200, which is equipped with a function for performing inflated lattice precoding (ILP) on transmission data, and a receiver device 300, which receives a signal transmitted from the transmitter device and restores data, there is adopted a feature wherein “coefficient α” which is required when the transmitter device 200 performs the above-mentioned ILP, and which is also required when the receiver device performs data restoration, is uniquely derived using information relating to an MCS (modulation parameter) that is applied with respect to the wireless communication system (more specifically, a feature wherein a “coefficient table part,” which uniquely maps MCS information to coefficient α, is provided at both the transmitter device and the receiver device, and wherein coefficient α required at both the transmitter device and the receiver device is derived using this “coefficient table part”), thereby evading having to exchange information relating to “coefficient α” between the transmitter device and the receiver device.

### TECHNICAL FIELD

The present invention relates to a transmitter device, receiver device and wireless communication system which perform wireless communication with interference suppressed.

### BACKGROUND ART

With respect to communication systems, if a transmitter device is able to know in advance the interference signal component contained in the reception signal of a receiver device, it is possible to have the receiver device be substantially unaffected by interference, by subtracting (cancelling) the interference signal component from the transmission signal at the transmitter device in advance.

However, there was a problem with thus subtracting the interference signal component from the transmission signal in that the transmission power would increase with the interference signal power. In order to solve this problem, there has been proposed a method referred to as Tomlinson-Harashima Precoding (THP) which is capable of suppressing the increase in transmission power by performing a remainder (modulo) operation on a communication signal at both the transmitter and receiver devices (Non-Patent Document 1 mentioned below).

In addition, lattice precoding extended to a discussion involving an n-dimensional space (where n is an integer equal to or greater than 2) based on THP has been proposed (Non-Patent Document 2 mentioned below).

An n-dimensional modulo operation is used in lattice precoding.

Further, there has been proposed a method referred to as inflated lattice precoding (ILP), which, as compared to when THP is simply used, is capable of improving error rate characteristics (lowering error rates) by, in performing communications using THP or lattice precoding, multiplying the interference signal component to be subtracted from the transmission signal at the transmitter device by an appropriate coefficient α (0<α≦1) (such that the reception signal to interference and noise power ratio at the receiver device is maximized) to transmit the interference signal component without completely canceling it, and multiplying the reception signal with the same coefficient α at the receiver device as well (Non-Patent Document 3 mentioned below).

FIG. 7 is a schematic diagram showing a signal flow with respect to a wireless communication system that uses conventional ILP.

In FIG. 7, desired signal s represents a signal that a transmitter device B is to transmit to a receiver device C (modulated symbols of transmission data), and estimated signal s′ represents an estimation result for desired signal s as derived by the receiver device C from the reception signal. In addition, interference signal f represents the interference signal component received at the receiver device C as included in the reception signal, and it is assumed that this interference signal f is known to the transmitter device B in advance.

For purposes of brevity, a description will now be provided assuming the propagation channel between the transmitter device B and the receiver device C is an additive white Gaussian noise (AWGN) channel.

At the transmitter device B, known interference signal f is first multiplied by coefficient α at a transmission coefficient multiplier part 101, and αf is outputted.

At an interference subtractor part 103, this interference signal αf that has been multiplied by α is subtracted from desired signal s, and (s−αf) is outputted.

At a transmission modulo operator part 105, a modulo operation (Mod_{τ}) with a modulo width of τ is performed with respect to (s−αf), and Mod_{τ}(s−αf) is outputted. Here, modulo operation Mod τ(ν) for a given complex vector, ν, is represented by Eq.1. It is noted that j represents an imaginary unit, and floor (a) the largest integer not exceeding a, and that Re(ν) and Im(ν) respectively represent the real part (corresponding to the in-phase component of a signal) and imaginary part (corresponding to the quadrature component of a signal) of complex number ν.

$${Mod}_{r} ( v ) = v - floor ( \frac{Re ( v ) + \frac{τ}{2}}{τ} ) τ - j \cdot floor ( \frac{Im ( v ) + \frac{τ}{2}}{τ} ) τ \qquad [ Eq . 1 ]$$

At a wireless transmitter part 107, the result of the modulo operation, Mod_{τ}(s−αf), is transmitted from a transmit antenna 111 as transmission signal x.

At the receiver device C, there is received reception signal y (=x+f+n) in which interference signal f is added to transmission signal x received by a wireless receiver part 117 via an antenna 115 and in which noise n is further added thereto.

A reception coefficient multiplier part 121 multiplies reception signal y by the same coefficient α as that by which interference signal f was multiplied at the transmission coefficient multiplier part 101 of the transmitter device B, and outputs αy.

Using modulo width τ′, which is such that its ratio with respect to the Euclidean distance of estimated signal s′ would be the same as the ratio of the Euclidean distance of desired signal s to modulo width τ of the transmission modulo operator part 105 at the transmitter device B, a reception modulo operator part 123 performs a modulo operation (Mod_{τ′}), and outputs estimated signal s′ (=Mod_{τ′}(αy)).

Here, by determining coefficient α as in Eq.2, the error between desired signal s and estimated signal s′ may be minimized, and, as compared to when THP is simply used (equivalent to α=1 with respect to ILP), error rate characteristics may be improved (Non-Patent Document 3 mentioned below). It is noted that σₓ^{e} represents the variance of transmission signal x, and σₙ² the variance of noise n. σₓ^{e}/σₙ² is equivalent to the signal to noise power ratio (SNR).

$$α = \frac{{σ}_{x}^{2}}{{σ}_{n}^{2} + {σ}_{x}^{2}} = \frac{S N R}{1 + S N R} \qquad [ Eq . 2 ]$$

### PRIOR ART DOCUMENTS

### Non-Patent Documents

Non-Patent Document 1: Harashima et al., “Matched-Transmission Technique for Channels With Intersymbol Interference”, IEEE Transaction on Communications, Vol. COM-20, No. 4, p. 774-780, August 1972
Non-Patent Document 2: S. Brink et al., “Doping of repeat-accumulate codes for dirty paper coding”, EUSIPCO 2004, p. 1553-1556, September 2004
Non-Patent Document 3: R. F. H. Fischer, “The Modulo-Lattice Channel: The Key Feature in Precoding Schemes”, AEU-Int. Journal of Electronics and Communications, p. 244-253, June 2005

### SUMMARY OF THE INVENTION

### Problems to be Solved by the Invention

However, there was a problem with ILP in that coefficient α common to both the transmitter device B and the receiver device C has to be applied, and the transmitter device B has to notify the receiver device C of coefficient α, resulting in an increase in control information.

An object of the present invention is to prevent an increase in control information by not adding coefficient α, which is used in common at the transmitter device and the receiver device, to the control information with which the transmitter device notifies the receiver device.

### Means for Solving the Problems

According to one aspect of the present invention, there is provided a wireless communication system in which, at a transmitter device, an interference signal component, which corresponds to an interference signal contained in a reception signal of a receiver device, is multiplied by a coefficient and subtracted from a desired signal, and a modulo operation is performed on a result of the subtraction which is then transmitted, wherein the coefficient, which is used in common at the transmitter device and the receiver device, is uniquely mapped from a modulation parameter of the desired signal and shared between the transmitter device and the receiver device. With respect to the modulation parameter (MCS), which is determined based on the SNR at the receiver device, the coefficient to be used in common at the transmitter device and the receiver device is uniquely mapped, and is shared between the transmitter device and the receiver device, as a result of which it becomes unnecessary to add control information with which the transmitter device notifies the receiver device of the coefficient, and it is possible to avoid an increase in control information.

It is preferable that there be shared, between the transmitter device and the receiver device, mapping information (a table, etc.) that uniquely maps the coefficient from modulation parameter information that notifies a modulation parameter of the desired signal. It is preferable that the receiver device notify the transmitter device of the mapping information prior to data communication.

In addition, the present invention is a transmitter device in a wireless communication system in which, at the transmitter device, an interference signal component, which corresponds to an interference signal contained in a reception signal of a receiver device, is multiplied by a coefficient and subtracted from a desired signal, and a modulo operation is performed on a result of the subtraction which is then transmitted, wherein the coefficient is determined in accordance with a modulation parameter of the desired signal addressed to the receiver device. It is preferable that there be shared, with the receiver device, mapping information that uniquely maps the coefficient from the modulation parameter of the desired signal.

In addition, there is provided a transmitter device in a wireless communication system in which, at the transmitter device, an interference signal component, which corresponds to an interference signal contained in a reception signal of a receiver device, is multiplied by a coefficient and subtracted from a desired signal, and a modulo operation is performed on a result of the subtraction which is then transmitted, the transmitter device comprising: an information mapping information storage part that holds combinations of respective modulation parameters and coefficients; a modulation parameter selector part that selects a modulation parameter of the desired signal to be transmitted to the receiver device; a transmission coefficient multiplier part that reads out from the coefficient table part a coefficient mapped to the selected modulation parameter and multiplies the interference signal component, which corresponds to interference that the receiver device is subjected to, thereby; an interference subtractor part that subtracts the interference signal component, as multiplied by the coefficient, from the desired signal to be transmitted to the receiver device, which is generated by applying the selected modulation parameter; and a transmission modulo operator part that performs a modulo operation on a result of the subtraction. It is preferable that it further comprise a modulation parameter information generator part that generates modulation parameter information for notifying the receiver device of the selected modulation parameter. It is preferable that it further comprise a propagation channel information acquisition part that acquires channel quality information representing reception quality notified from the receiver device, and that the modulation parameter selector part select the modulation parameter based on the channel quality information.

In addition, the present invention is a receiver device in a wireless communication system in which, at a transmitter device, an interference signal component, which corresponds to an interference signal contained in a reception signal of the receiver device, is multiplied by a coefficient and subtracted (canceled) from a desired signal, and a modulo operation is performed on a result of the subtraction which is then transmitted, wherein the coefficient is identified based on a modulation parameter of the desired signal contained in the reception signal, the reception signal is multiplied by the coefficient, and a modulo operation is performed on a result of the multiplication. It is preferable that mapping information that uniquely maps the coefficient from the modulation parameter of the desired signal be shared with the transmitter device.

In addition, the present invention is a receiver device in a wireless communication system in which, at a transmitter device, an interference signal component, which corresponds to an interference signal contained in a reception signal of the receiver device, is multiplied by a coefficient and subtracted from a desired signal, and a modulo operation is performed on a result of the subtraction which is then transmitted, the receiver device comprising: a mapping information storage part that holds combinations of respective modulation parameters and coefficients; a modulation parameter information detector part that acquires a modulation parameter of the desired signal in the reception signal; a reception coefficient multiplier part that reads out from the coefficient table part a coefficient corresponding to the acquired modulation parameter and multiplies the reception signal thereby; and a reception modulo operator part that performs a modulo operation on a result of the multiplication. It is preferable that it further comprise: a propagation channel estimation part that estimates reception quality based on the reception signal or a pilot signal; and a propagation channel information generator part that generates channel quality information that represents, and is for notifying the transmitter device of, an estimation result for the reception quality.

According to another aspect of the present invention, there is provided a communication method for a communication system in which coefficient α, which is used in common at a transmitter device and a receiver device, is uniquely mapped from a modulation parameter of a desired signal and shared between the transmitter device and the receiver device, the communication method comprising: at the transmitter device, a step of multiplying an interference signal component, which corresponds to an interference signal contained in a reception signal of the receiver device, by the coefficient corresponding to the modulation parameter of the desired signal and subtracting (cancelling) it from the desired signal, and a step of performing a modulo operation on a result of the subtraction and of transmitting a transmission signal; and at the receiver device, a step of receiving the transmission signal, multiplying it by the coefficient corresponding to the modulation parameter of the desired signal, and performing a modulo operation on a result of the multiplication.

In addition, the present invention may also be a program for causing a computer to execute the method described above, as well as a computer-readable recording medium on which such a program is recorded. The program may also be acquired via a transmission medium, such as the Internet, etc.

The contents of the specification and/or drawings of JP Patent Application No. 2009-122915, from which the present application claims priority, as well as of the basic application thereof, namely JP Patent Application No. 2009-248452, are incorporated into the present specification.

### Effects of the Invention

With the present invention, with respect to a wireless communication system employing ILP, by mapping coefficient α, which is used in common at a transmitter device and a receiver device, to the MCS that is to be applied to data communications from the transmitter device to the receiver device, it becomes unnecessary to add control information for notifying coefficient α, and it is thus possible to prevent an increase in control information.

### BRIEF DESCRIPTION OF THE DRAWINGS

FIG. 1 is a figure showing a configuration example of a wireless communication system according to an embodiment of the present invention.

FIG. 2 is a functional block diagram showing a configuration example of a transmitter device.

FIG. 3 is a functional block diagram showing a configuration example of a receiver device.

FIG. 4 is a figure showing, with respect to a complex plane comprising an in-phase component and a quadrature component, examples of constellation points of a signal with respect to various parts of a transmitter device in the case of QPSK modulation.

FIG. 5 is a figure showing, with respect to a complex plane comprising an in-phase component and a quadrature component, examples of constellation points of a signal with respect to various parts of a receiver device in the case of QPSK modulation.

FIG. 6 is a figure showing an example of a mapping table of MCS and coefficient α with respect to a coefficient table part 57.

FIG. 7 is a schematic diagram showing a signal flow with respect to a wireless communication system employing conventional ILP.

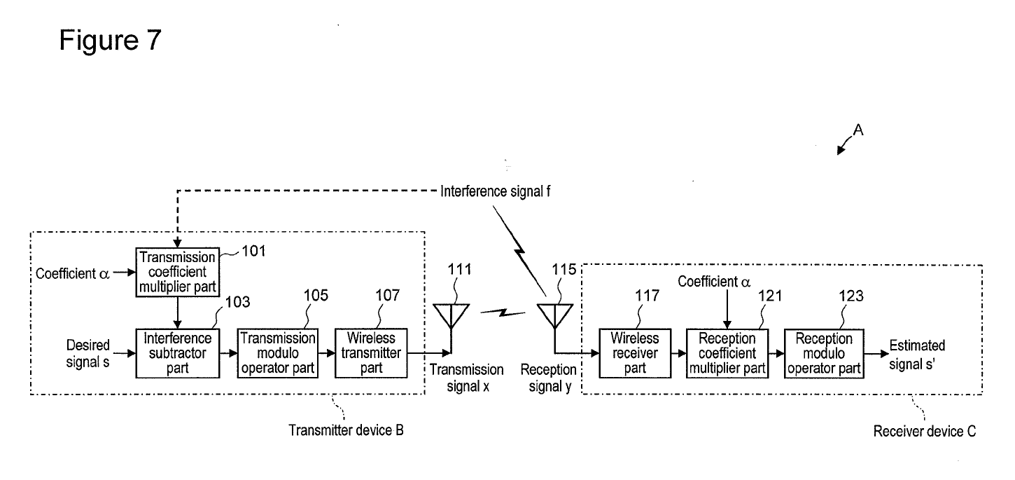

FIG. 8 is a functional block diagram showing a configuration example of a transmitter device with respect to the second embodiment of the present invention.

FIG. 9 is a functional block diagram showing a configuration example of a receiver device with respect to the second embodiment of the present invention.

FIG. 10 is a flowchart showing an example of a communication procedure between a transmitter device and a receiver device of the present embodiment.

FIG. 11 is a flowchart showing an example of a coefficient table update procedure with respect to a state of ongoing communication between a transmitter device and a receiver device of the present embodiment.

FIG. 12 is a functional block diagram showing a configuration example of a transmitter device with respect to the third embodiment of the present invention.

FIG. 13 is a functional block diagram showing a configuration example of a receiver device with respect to the third embodiment of the present invention.

FIG. 14 is a flowchart showing an example of a communication procedure between a transmitter device and a receiver device of the present embodiment.

FIG. 15 is a functional block diagram showing a configuration example of a transmitter device with respect to the fourth embodiment of the present invention.

FIG. 16 is a functional block diagram showing a configuration example of a receiver device with respect to the fourth embodiment of the present invention.

FIG. 17 is a flowchart showing an example of a communication procedure between a transmitter device and a receiver device of the present embodiment.

### LIST OF REFERENCE NUMERALS

100. . . interfering station device, 200 . . . transmitter device, 300 . . . receiver device, 1 . . . antenna part, 3 . . . wireless receiver part, 5 . . . propagation channel information acquisition part, 7 . . . MCS selector part, 11 . . . MCS information generator part, 17 . . . interference calculator part, 21 . . . coefficient table part (mapping information storage part), 23 . . . transmission coefficient multiplier part, 25 . . . transmission modulo operator part, 27 . . . interference subtractor part, 31 . . . modulator part, 33 . . . encoder part, 51 . . . antenna part, 53 . . . wireless receiver part, 55 . . . MCS information detector part, 57 . . . coefficient table part (mapping information holding part), 61 . . . modulo width calculator part, 63 . . . pilot separator part, 65 . . . propagation channel compensation part, 67 . . . reception coefficient multiplier part, 71 . . . reception modulo operator part, 73 . . . demodulator part, 75 . . . decoder part, 81 . . . propagation channel estimation part, 83 . . . propagation channel information generator part, 85 . . . wireless transmitter part.

### MODES FOR CARRYING OUT THE INVENTION

### First Embodiment

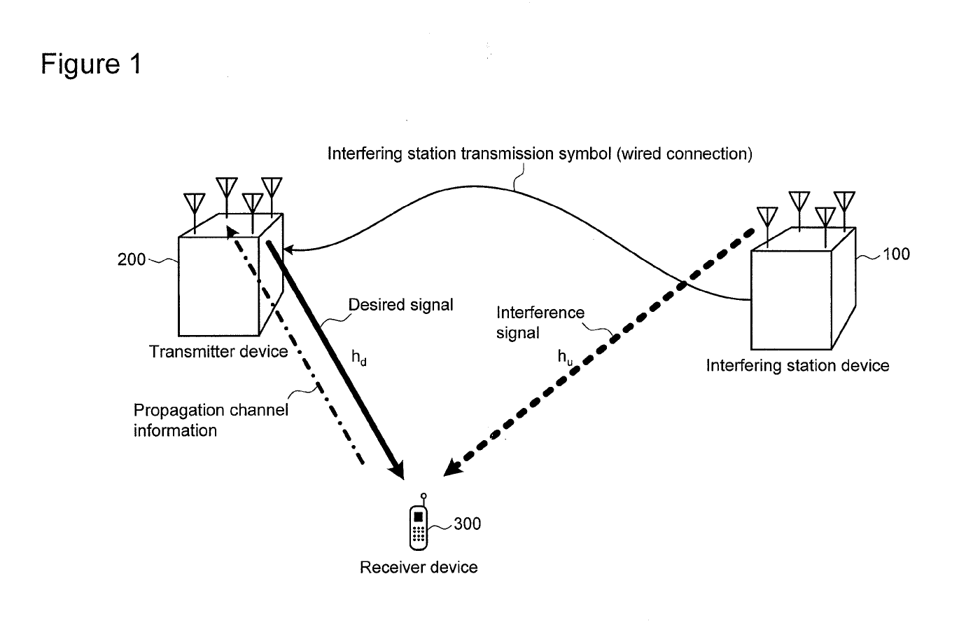

FIG. 1 is a figure showing a schematic configuration example of a wireless communication system with respect to the first embodiment of the present invention.

As shown in FIG. 1, for a wireless communication system with respect to the present embodiment, there is assumed a wireless communication in which, with respect to a desired signal with which a transmitter device 200 transmits data to a receiver device 300, a signal transmitted by an interfering station device 100 is received by the receiver device 300 as an interference signal. A specific example might include a case where, with respect to two base station devices (or relay station devices, etc.) that constitute different cells or sectors in a cellular system, there exists a terminal device that communicates with one of those base station devices, and a signal that the other base station device transmits to another terminal device is received by the terminal device.

The transmitter device 200 is, in advance and via a wired network or the like, notified of transmission symbols that the interfering station device 100 is to transmit (interfering station transmission symbols).

The transmitter device 200 derives the interference signal that the receiver device 300 receives from the interfering station device 100, and transmits to the receiver device 300 a transmission signal on which inflated lattice precoding (ILP) has been performed.

At the receiver device 300, the desired signal from the transmitter device 200 and that has undergone ILP is received after being combined with the interference signal from the interfering station device 100, and, by performing signal processing corresponding to ILP, it is possible to carry out reception with suppressed characteristics degradation caused by the interference signal and noise.

It is noted that, in the present embodiment, the pilot signal transmitted by the transmitter device 200 and the pilot signal transmitted by the interfering station device 100 are made orthogonal through time division multiplexing, frequency division multiplexing, code division multiplexing, etc., and it is assumed that each is individually receivable (i.e., without interfering with each other) at the receiver device 300

In addition, h_{d} denotes the complex propagation channel gain of the propagation channel from the transmitter device 200 to the receiver device 300, and hᵤ denotes the complex propagation channel gain of the propagation channel from the interfering station device 100 to the receiver device 300.

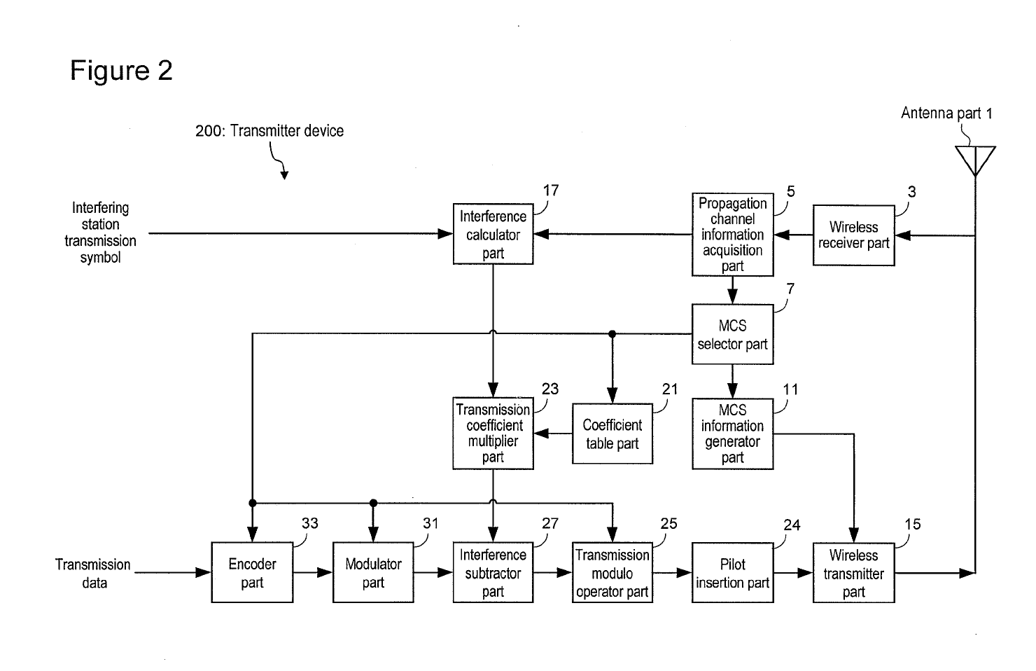

FIG. 2 is a functional block diagram showing a configuration example of the transmitter device 200 with respect to the present embodiment.

As shown in FIG. 2, a wireless receiver part 3 receives, via an antenna part 1, a signal in which is contained propagation channel information that is notified from the receiver device 300.

A propagation channel information acquisition part 5 detects propagation channel information from the received signal. It is noted that in this propagation channel information are contained a value representing reception quality based on the signal to noise power ratio (SNR) at the receiver device 300, e.g., channel quality information (Channel Quality Indicator: CQI), and, further, values representing complex propagation channel gain h_{d} of the propagation channel from the transmitter device 200 to the receiver device 300 and complex propagation channel gain hᵤ of the propagation channel from the interfering station device 100 to the receiver device 300, e.g., channel state information (CSI). These are separated and outputted. A description is provided below using CQI as a value representing reception quality, and CSI as a value representing complex propagation channel gain. It is noted that signal to noise power ratio may also be calculated based on complex propagation channel gain without using CQI.

CQI is inputted to an MCS selector part (modulation parameter selector part) 7 from the propagation channel information acquisition part 5, and, based on the CQI, the MCS selector part 7 selects a modulation parameter comprising a modulation scheme for transmission to the receiver device 300, an error correction coding scheme, a code rate, a transmission data size (transport block size), a spreading factor, or a combination thereof. It is noted that the present embodiment will be described by taking as an example a case where a combination of a modulation scheme and a coding scheme (code rate) (Modulation and channel Coding Scheme: MCS) is used as a modulation parameter. In addition, with respect to the criteria for MCS selection, it is preferable that there be used error rate criteria, where the MCS of the greatest transmission rate that meets the requisite error rate with respect to the reception quality indicated by the CQI is selected, or throughput criteria, where the MCS that attains the greatest throughput with respect to the reception quality indicated by the CQI is selected, etc.

An MCS information generator part (modulation parameter information generator part) 11 generates MCS information for notifying the receiver device 300 of the selected MCS. It is noted that the MCS information may be notified to the receiver device 300 using a control signal for control information notification, or it may be transmitted by being multiplexed with a data signal.

By multiplying interfering station transmission symbols, which are symbols that the interfering station device 100 is to transmit and that are notified from the interfering station device 100, by complex propagation channel gain hᵤ of the propagation channel from the interfering station device 100 to the receiver device 300 as indicated by the CSI, the interference calculator part 17 derives an interference signal that the receiver device 300 is subjected to. By further dividing it by complex propagation channel gain h_{d} of the propagation channel from the transmitter device 200 to the receiver device 300 as indicated by the CSI, it compensates for the effects of the propagation channel from the transmitter device 200 to the receiver device 300. An interference signal component, which is such that it will be cancelled out with the interference signal from the interfering station device 100 at the receiver device 300, is thus calculated.

From a mapping information holding part (table) that holds mapping information uniquely mapping MCS to coefficient α, a coefficient table part 21 derives and outputs coefficient α corresponding to the MCS selected at the MCS selector part 7. It is noted that, instead of a table, there may also be used a means that uniquely derives coefficient α from the selected MCS with coefficient α as a function of MCS.

A transmission coefficient multiplier part 23 multiplies the interference signal component calculated at the interference calculator part 17 by coefficient α. In other words, the amplitude of the interference signal component is multiplied by α.

With the code rate of the MCS selected at the MCS selector part 7, the encoder part 33 performs, on the transmission data addressed to the receiver device 300, error correction coding and rate matching (puncturing or repetition), and outputs encoded data.

A modulator part 31 modulates the encoded data by the modulation scheme of the MCS selected at the MCS selector part 7, and outputs modulated symbols (desired signal).

An interference subtractor part 27 subtracts the interference signal component outputted by the transmission coefficient multiplier part 23, which has been multiplied by coefficient α, from the modulated symbols outputted by the modulator part 31 and outputs them.

A transmission modulo operator part 25 derives modulo width r corresponding to the modulation scheme of the MCS selected at the MCS selector part 7, and, with that modulo width τ, performs a modulo operation on each of the in-phase component and quadrature component of the modulated symbols outputted by the interference subtractor part 27 and from which the interference signal component has been subtracted, thereby generating and outputting a data signal to be transmitted. It is noted that modulo width τ need only be of a value greater than the width of the constellation of the modulated symbols of each modulation scheme. By way of example, with respect to a constellation point amplitude that has been normalized in such a manner that the average power would be 1 so that constellation points would be repeated at the minimum Euclidean distance, it is preferable that it be defined as 2×2^{1/2} in the case of quaternary phase shift keying (QPSK), as 8/10^{1/2} in the case of 16 quadrature amplitude modulation (16-QAM), as 16/42^{1/2} in the case of 64 quadrature amplitude modulation (64-QAM), and so forth.

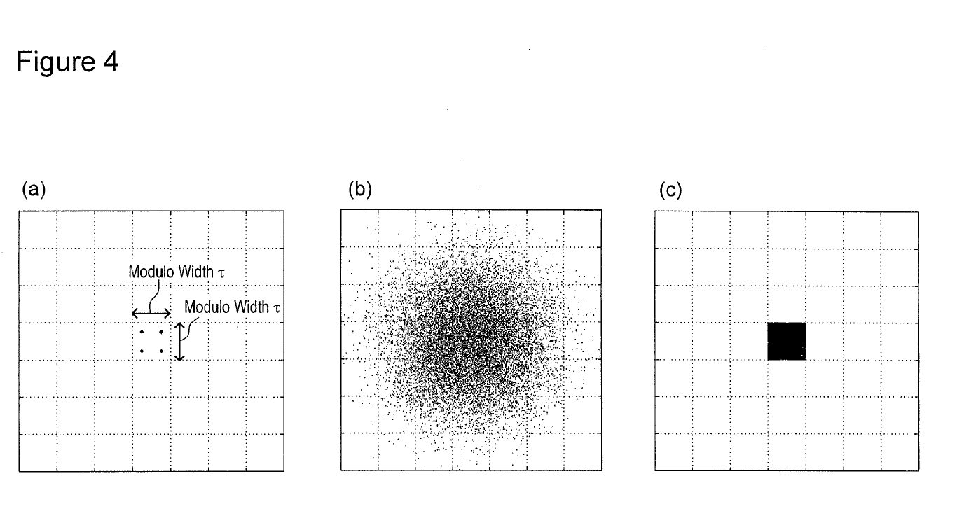

FIG. 4 is a figure in which examples of constellation points of a signal with respect to various parts of the transmitter device 200 in the case of QPSK modulation are shown in complex planes comprising an in-phase component and a quadrature component. It is noted that in FIG. 4, for purposes of brevity, there are shown constellation points for a case where α=1.

FIG. 4(a) is a constellation of modulated symbols outputted by the modulator part, showing a case where modulo width r is defined as 2×2^{1/2} as mentioned above.

FIG. 4(b) is the result of subtracting the interference signal component from the modulated symbols at the interference subtractor part.

FIG. 4(c) is the result of performing a modulo operation of modulo width r at the transmission modulo operator part.

A pilot insertion part 24 multiplexes a pilot signal with the data signal to be transmitted. For the multiplexing method, it is preferable that time division multiplexing, frequency division multiplexing, etc., be employed. In addition, it is preferable that there be employed a pilot signal that is made orthogonal to a pilot signal transmitted by another transmitter device (interfering station device 100) by time division multiplexing, frequency division multiplexing, code division multiplexing, etc. In addition, the amplitude of the pilot signal is arranged in such a manner that its ratio to modulo width τ, or to the width of the constellation of the modulated symbols, is a pre-defined value.

A wireless transmitter part 15 transmits via an antenna part the data signal, with which MCS information and the pilot signal have been multiplexed.

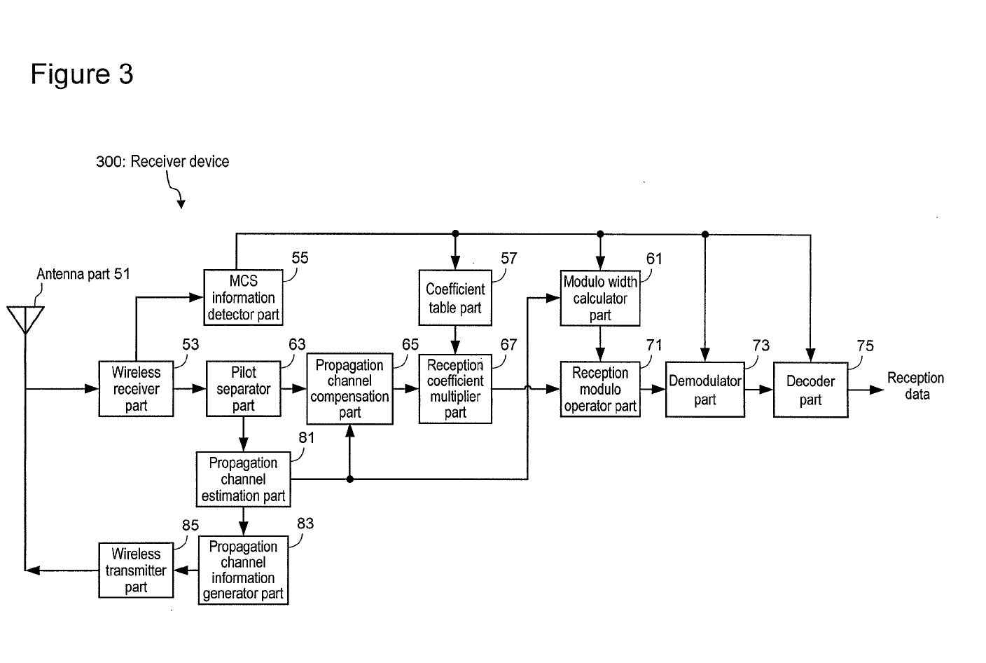

FIG. 3 is a functional block diagram showing a configuration example of the receiver device 300 with respect to the present embodiment.

Via an antenna part 51, a wireless receiver part 53 receives the data signal, with which the MCS information and the pilot signal have been multiplexed, that has been transmitted by the transmitter device 200.

An MCS information detector part (modulation parameter information detector part) 55 detects from the reception signal the MCS information that has been notified by the transmitter device 200, and acquires the MCS used on the data signal from the transmitter device 200.

From a table holding mapping information that uniquely maps MCS to coefficient α, a coefficient table part (mapping information holding part) 57 derives and outputs coefficient α corresponding to the MCS acquired at the MCS information detector part 55. Here, this table of MCS and coefficient α shares contents with the table of the coefficient table part 21 of the transmitter device 200. It is noted that, instead of a table, there may also be employed a means that uniquely derives coefficient α from the acquired MCS with coefficient α as a function of MCS.

A pilot separator part 63 extracts the pilot signal from the reception signal, thereby separating it into the pilot signal and the data signal. In the present embodiment, each of the pilot signal from the transmitter device 200 and the pilot signal from the interfering station device 100 is extracted here.

Using the pilot signal from the transmitter device 200 outputted by the pilot separator part 63, a propagation channel estimation part 81 estimates and outputs the SNR and complex propagation channel gain h_{d} of the propagation channel from the transmitter device 200 to the receiver device 300. Further, using the pilot signal from the interfering station device 100, it estimates and outputs complex propagation channel gain hᵤ of the propagation channel from the interfering station device 100 to the receiver device 300.

Using complex propagation channel gain h_{d} outputted by the propagation channel estimation part 81, a propagation channel compensation part 65 performs propagation channel compensation on the data signal. By way of example, phase and amplitude are compensated by multiplying the data signal by 1/h_{d}. Alternatively, just the phase may be compensated through multiplication by |h_{d}|/h_{d}.

A reception coefficient multiplier part 67 multiplies the data signal, which has undergone propagation channel compensation, by coefficient α. In other words, the amplitude of the data signal is multiplied by α.

Taking into account complex propagation channel gain h_{d} outputted by the propagation channel estimation part 81 (that is, taking into account the change in amplitude caused by the propagation channel compensation of the data signal at the propagation channel compensation part 65), and with the amplitude of the pilot signal received from the transmitter device 200 and separated at the pilot separator part 63 as a reference, a modulo width calculator part 61 calculates modulo width τ′ corresponding to the modulation scheme of the MCS detected at the MCS information detector part 55. Specifically, the magnitude of modulo width τ′ relative to the width of the constellation of the reception signal is made equal to the ratio of the width of the constellation of the modulated symbols of each modulation scheme with respect to the transmission modulo operator part 25 of the transmitter device 200 to modulo width τ.

Using modulo width τ′ calculated at the modulo width calculator part 61, a reception modulo operator part 71 performs a modulo operation on each of the in-phase component and quadrature component of the data signal that has been multiplied by coefficient α at the reception coefficient multiplier part 67, and outputs reception modulated symbols.

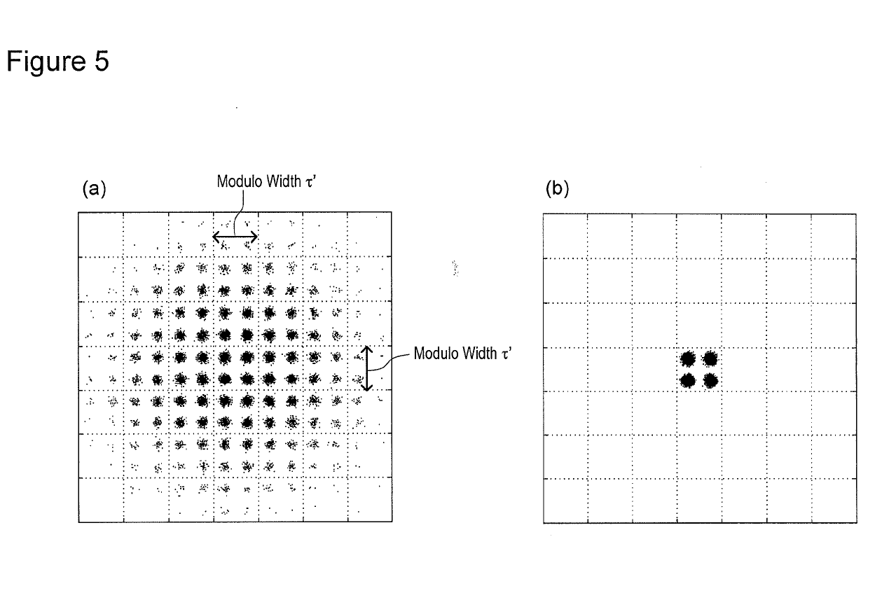

FIG. 5 is a figure in which examples of constellation points of a signal with respect to various parts of the receiver device 300 in the case of QPSK modulation are shown in complex planes comprising an in-phase component and a quadrature component. It is noted that in FIG. 5, for purposes of brevity, there are shown constellation points for a case where α=1.

FIG. 5(a) is a constellation of a data signal outputted by the pilot separator part 63. The distribution is such that QPSK modulated constellation points with noise are repeated at widths of modulo width τ′.

FIG. 5(b) is the result of performing a modulo operation of modulo width τ′ the reception modulo operator part 71.

A demodulator part 73 demodulates the reception modulated symbols through the modulation scheme of the MCS detected at the MCS information detector part 55, and outputs reception encoded data.

With the code rate of the MCS detected at the MCS information detector part 55, a decoder part 75 performs, on the reception encoded data, rate matching (depuncturing, or combining, or deletion), which is the opposite manipulation to the rate matching at the encoder part 33 of the transmitter device 200, and error correction decoding, thereby outputting reception data.

A propagation channel information generator part 83 generates CQI, which represents the signal to noise power ratio outputted by the propagation channel estimation part 81, and CSI, which represents complex propagation channel gain h_{d} and complex propagation channel gain hᵤ, and generates and outputs propagation channel information that contains the above. It is noted that, instead of using CQI, complex propagation channel gain h_{d} may be notified to the transmitter device, and the signal to noise power ratio may be calculated at the transmitter device.

A wireless transmitter part 85 transmits, to the transmitter device 200 via the antenna part 51, the propagation channel information outputted by the propagation channel information generator part 83.

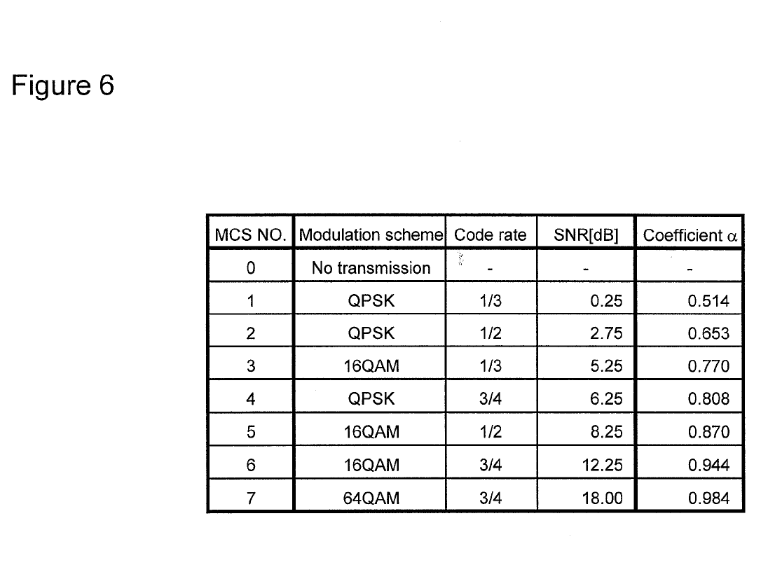

FIG. 6 is an example of a mapping table of MCS and coefficient α that is shared by the coefficient table part 21 and the coefficient table part 57.

In FIG. 6, eight MCS's are defined as combinations of various modulation schemes and code rates (including the case of no transmission), and an example of a requisite SNR in applying each MCS is indicated. Coefficients α as calculated based on such requisite SNR's using Equation (2) mentioned above are mapped to the respective MCS's.

It is noted that, with respect to FIG. 6, a description has been provided for an example in which a table is created by calculating the value of coefficient α based on the SNR required in applying each MCS. However, the present invention is by no means limited as such. Instead, a table may be created by calculating the value of coefficient α for each MCS using the requisite SNR (the minimum SNR for selecting that MCS), the requisite SNR of a superior MCS (the maximum SNR for selecting that MCS), or an SNR therebetween.

### Second Embodiment

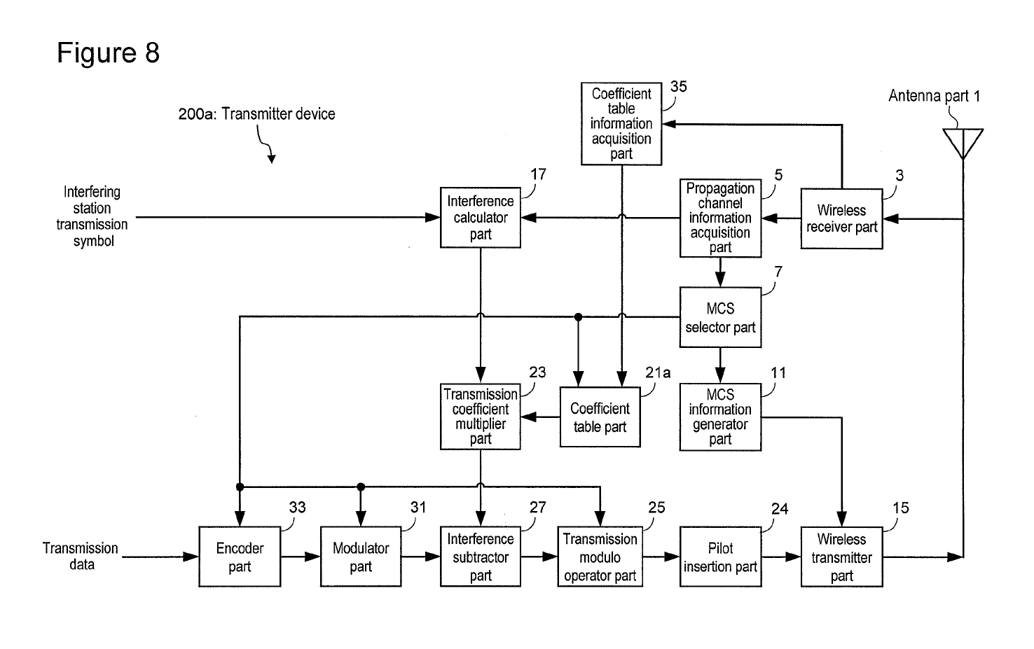

FIG. 8 is a functional block diagram showing a configuration example of a transmitter device 200a with respect to the second embodiment of the present invention. A description will be provided here only with respect to parts that differ from the transmitter device 200 in FIG. 2, while omitting descriptions for like parts.

A coefficient table information acquisition part 35 detects coefficient table information notified by a receiver device 300a, which is included in the signal received by the wireless receiver part 3 via the antenna part 1. If coefficient table information is detected, the detected coefficient table information is outputted to a coefficient table part 21a.

Once coefficient table information is inputted, the coefficient table part 21a replaces the coefficient table it holds with the inputted coefficient table information.

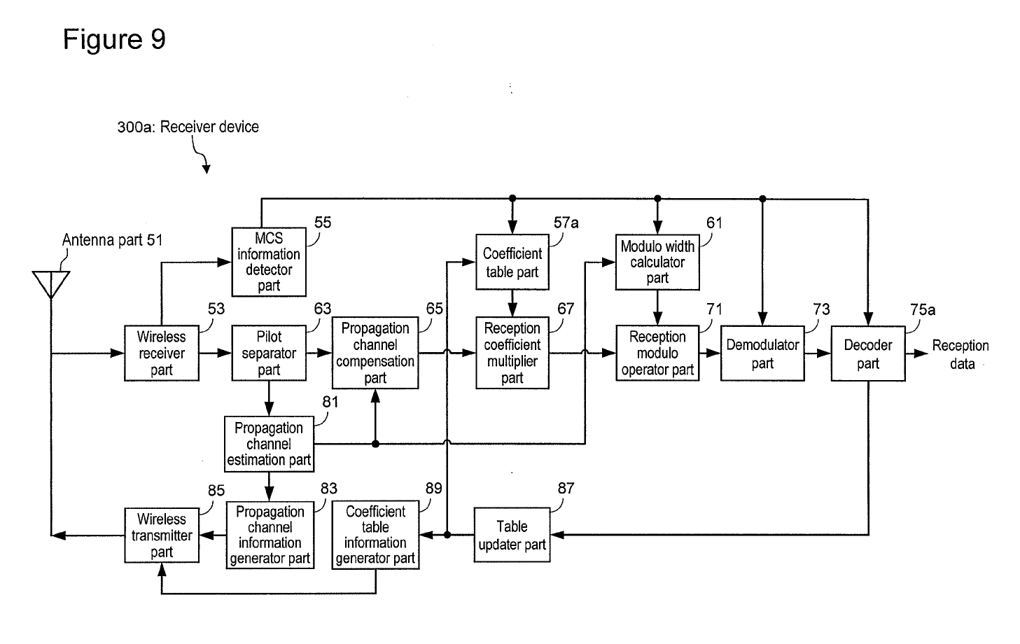

FIG. 9 is a functional block diagram showing a configuration example of the receiver device 300a with respect to the second embodiment of the present invention. A description will be provided here only with respect to parts that differ from the transmitter device 300 in FIG. 3, while omitting descriptions for like parts.

A decoder part 75a examines whether or not there are any errors in the reception data on which error correction decoding has been performed, and outputs an error examination result.

A table updater part 87 monitors the error examination result outputted by the decoder part 75a, and if the error rate of the reception data is higher than the requisite error rate (many errors) or falls far below the requisite error rate (few errors), it recalculates (modifies) coefficient α for each MCS and generates a new coefficient table. In so doing, when the error rate is higher than the requisite error rate, it calculates coefficient α to be greater than it currently is, and when it is lower than the requisite error rate, it calculates coefficient α to be less than it currently is. In so doing, it is preferable that the selection threshold for each MCS (the SNR threshold for MCS selection) be so modified as to match the new requisite SNR. It is preferable that the modification results of the MCS selection thresholds be reflected in the generated values of CQI or that the new MCS selection thresholds be reported to the transmitter device.

A coefficient table part 57a replaces the coefficient table it holds with the coefficient table generated at the table updater part 87.

A coefficient table information generator part 89 generates coefficient table information for notifying the transmitter device of the coefficient table generated at the table updater part 87, and transmits it to the transmitter device 200a via the wireless transmitter part 85.

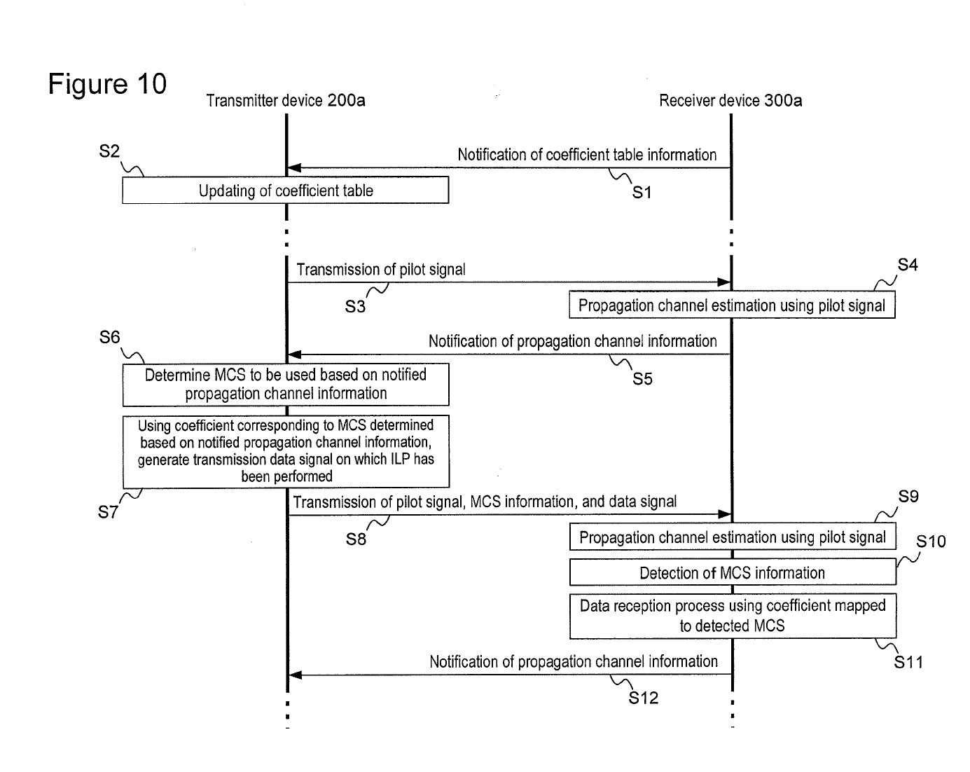

FIG. 10 is a flowchart showing an example of a communication procedure between the transmitter device 200a and the receiver device 300a of the present embodiment.

First, for example, when initiating communication, the transmitter device 200a is notified of the coefficient table information that the receiver device 300a holds (step S1).

Having received the coefficient table information, the transmitter device 200a updates the coefficient table part 21a with the received coefficient table information (stores the coefficient table information) (step S2).

In the communication state thereafter, the transmitter device 200a transmits a pilot signal (step S3). The receiver device 300a estimates the propagation channel state between the transmitter device 200a and the receiver device 300a using the reception result of the pilot signal transmitted by the transmitter device 200a (step S4), generates propagation channel information in which channel quality information CQI, channel state information CSI, etc., are contained, and notifies the transmitter device 200a of this propagation channel information (step S5).

Based on the notified propagation channel information, the transmitter device 200a determines the MCS to be used for data communication with the receiver device 300a (step S6). Coefficient α corresponding to the determined MCS is derived from the coefficient table held by the coefficient table part 21a, and there is generated a transmission data signal to which ILP is applied based on the notified propagation channel information (step S7). This transmission data signal is transmitted to the receiver device 300a along with the pilot signal and the MCS information for notifying the receiver device of the determined MCS (step S8).

The receiver device 300a receives the signals, performs propagation channel estimation using the reception result of the pilot signal (step S9), detects MCS information (step S10), reads out coefficient α corresponding to the detected MCS from the coefficient table held by the coefficient table part, and performs an ILP reception process using coefficient α that has been read out (step S11). In addition, from the propagation channel state estimation result, it generates propagation channel information in which channel quality information CQI, channel state information CSI, etc., are contained, and notifies the transmitter device 200a (step S12).

In the subsequent state of ongoing communication, the process from step S6 up to step S12 is repeated.

With the procedure above, even if the values of coefficient α mapped to the respective MCS's were to differ from receiver device to receiver device, that is, even if the coefficient table were to differ from receiver device to receiver device, the transmitter device 200a of the present embodiment would be able to share a coefficient table with each receiver device when initiating communication, for example.

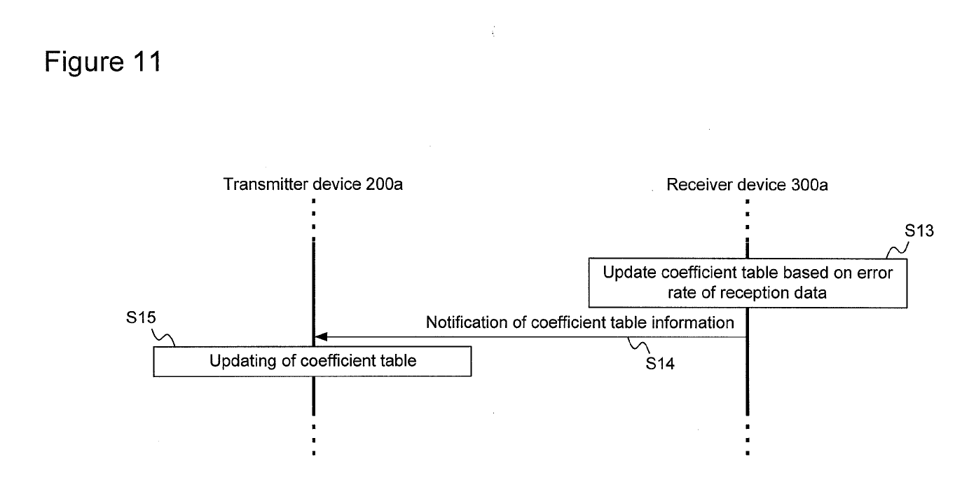

FIG. 11 is a flowchart showing an example of a coefficient table updating procedure with respect to a state of ongoing communication between the transmitter device 200a and the receiver device 300a of the present embodiment.

The receiver device 300a measures the error rate of the reception data, and, if it is higher than the requisite error rate (many errors) or if it falls far below the requisite error rate (few errors), updates the coefficient table based on the error rate of the reception data (step S13), and notifies the transmitter device 200a of the information of the updated coefficient table (step S14).

When coefficient table information is detected/received, the transmitter device 200a replaces and updates the coefficient table held by the coefficient table part 21a with the received coefficient table information (step S15).

With the procedure above, it becomes possible for the receiver device 300a of the present embodiment to, once it is sensed, while communicating with the transmitter device 200a and based on changes in the error rate of the reception data, that coefficients α stored in the coefficient table for the respective MCS's have ceased to be optimal (due to such factors as changes in the reception environment, temperature changes, changes over time, etc.), recalculate coefficient α for each MCS, update the coefficient table, and share the updated coefficient table by notifying the transmitter device 200a. Thus, it is possible to always maintain the coefficient table in an appropriate state.

It is noted that, with respect to the present embodiment, a description has been provided for a case in which the error rate of the reception data is used as a reference for performing a coefficient table updating process. However, the present invention is by no means limited as such. Instead, updates may be performed regularly with each passage of a given period of time, or irregularly.

### Third Embodiment

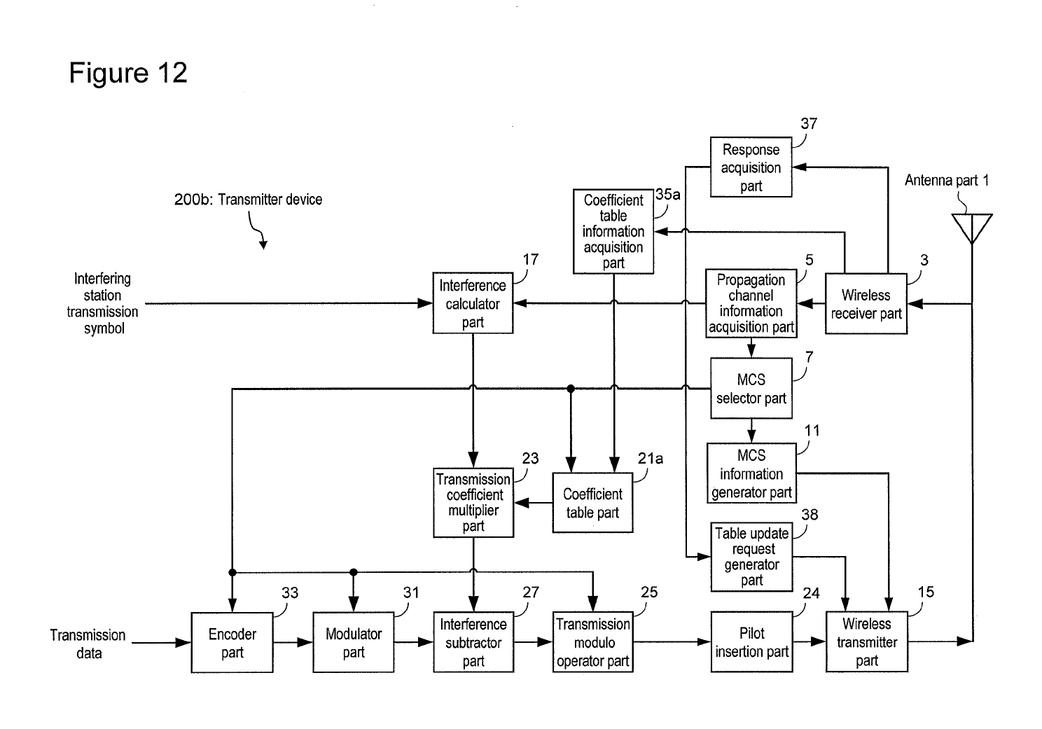

FIG. 12 is a functional block diagram showing a configuration example of a transmitter device 200b with respect to the third embodiment of the present invention. A description will be provided here only with respect to parts that differ from the transmitter device 200a in FIG. 8, while omitting descriptions for like parts.

A response acquisition part 37 detects a positive response indicating the fact that reception has been carried out successfully (ACK: Acknowledgment) or a negative response indicating the fact that reception has not been carried out successfully (NACK: Negative Acknowledgment), which is notified from a receiver device 300b and contained in a signal received by the wireless receiver part 3 via the antenna part 1.

If the error rate of the reception data measured at the response acquisition part 37 is higher than the requisite error rate (many errors), or if it falls far below the requisite error rate (few errors), a table update request generator part 38 generates a table update request requesting the receiver device 300b to update the coefficient table, and transmits it to the receiver device 300b via the wireless transmitter part 15.

A coefficient table information acquisition part 35a detects coefficient table information notified from the receiver device 300a, which is contained in the signal received by the wireless receiver part 3 via the antenna part 1. If coefficient table information is detected, the detected coefficient table information is outputted to the coefficient table part 21a.

Once coefficient table information is inputted, the coefficient table part 21 replaces the coefficient table it holds with the inputted coefficient table information.

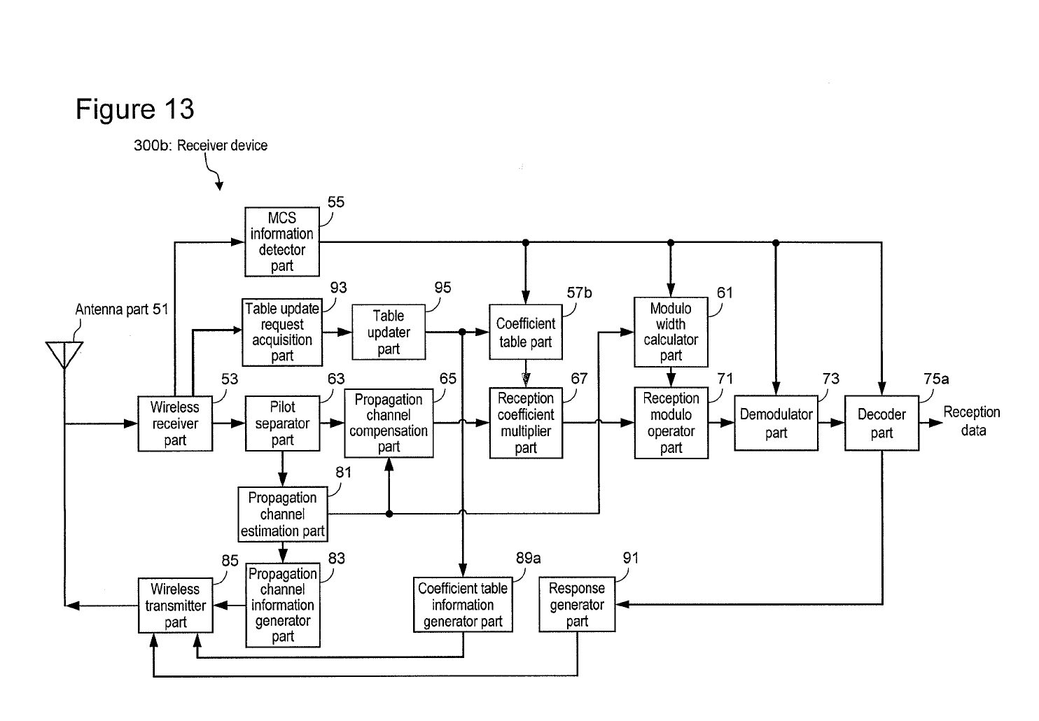

FIG. 13 is a functional block diagram showing a configuration example of the receiver device 300b with respect to the third embodiment of the present invention. A description will be provided here only with respect to parts that differ from the receiver device 300a in FIG. 9, while omitting descriptions for like parts.

Based on the error examination result outputted by the decoder part 75a, a response generator part 91 generates a positive response if no error was detected, or a negative response if an error was detected, and notifies the transmitter device 200b via the wireless transmitter part 85.

A table update request acquisition part 93 detects the table update request notified from the transmitter device 200b, which is contained in the signal received by the wireless receiver part 53 via the antenna part 51.

If a table update request is detected at the table update request acquisition part 93, a table updater part 95 calculates coefficient α for each MCS and generates a new coefficient table. In so doing, as in the second embodiment, the error examination result outputted by the decoder part 75a may be monitored, and coefficient α for each MCS recalculated (modified) based on the error rate of the reception data.

A coefficient table part 57b replaces the coefficient table it holds with the coefficient table generated at the table updater part 95.

A coefficient table information generator part 89a generates coefficient table information for notifying the transmitter device of the coefficient table generated at the table updater part 95, and transmits it to the transmitter device 200b via the wireless transmitter part 85.

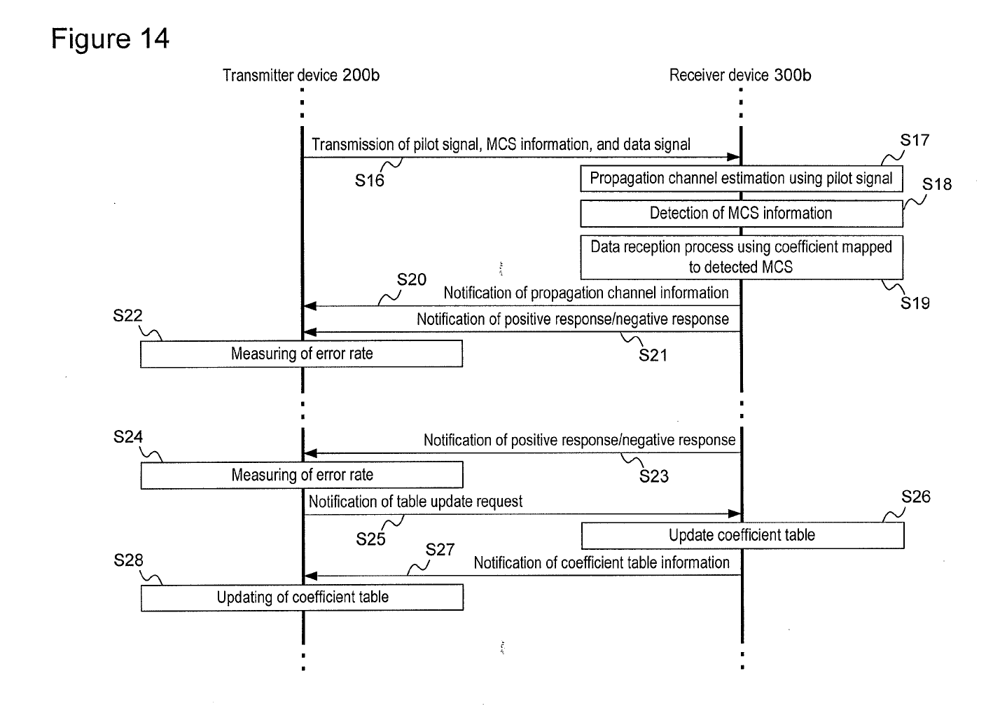

FIG. 14 is a flowchart showing an example of a communication procedure between the transmitter device 200b and the receiver device 300b of the present embodiment.

Since step S16 up to step S20 for the data communication procedure from the transmitter device 200b to the receiver device 300b are the same steps as step S8 up to step S12 of the communication procedure shown in FIG. 10 for the second embodiment, descriptions thereof will be omitted.

After the notification of propagation channel information in step S20, the receiver device 300b generates a positive response if no error is detected in the reception data, or a negative response if an error is detected, and notifies the transmitter device 200b (step S21 and step S23).

The transmitter device 200b receives the positive response or the negative response, and measures the error rate (step S22 and step S24). If, based on the measured error rate, it is determined that the coefficient table needs to be updated, namely, if the error rate is higher than the requisite error rate, or if it falls far below the requisite error rate, etc., it generates a table update request requesting an update of the coefficient table and notifies the receiver device 300b (step S25).

Having received the table update request, the receiver device 300b updates the coefficient table (step S26), and notifies the transmitter device 200b of information of the updated coefficient table (step S27).

The transmitter device 200b receives the coefficient table information, and replaces and updates the coefficient table held by the coefficient table part with the received coefficient table information (step S28).

With the procedure above, it becomes possible for the transmitter device 200b of the present embodiment to, once it is sensed, while communicating with the receiver device 300b and based on changes in the error rate of the reception data, that coefficients α stored in the coefficient table for the respective MCS's have ceased to be optimal (due to such factors as changes in the reception environment, temperature changes, changes over time, etc.), instruct the receiver device 300b to recalculate coefficient α for each MCS and update the coefficient table, thereby sharing the coefficient table updated by the receiver device 300b. Thus, it is possible to always maintain the coefficient table in an appropriate state.

It is noted that, with respect to the present embodiment, a description has been provided for a case in which the error rate of the reception data is used as a reference for performing a coefficient table updating process. However, the present invention is by no means limited as such. Instead, updates may be performed regularly with each passage of a given period of time, or irregularly.

### Fourth Embodiment

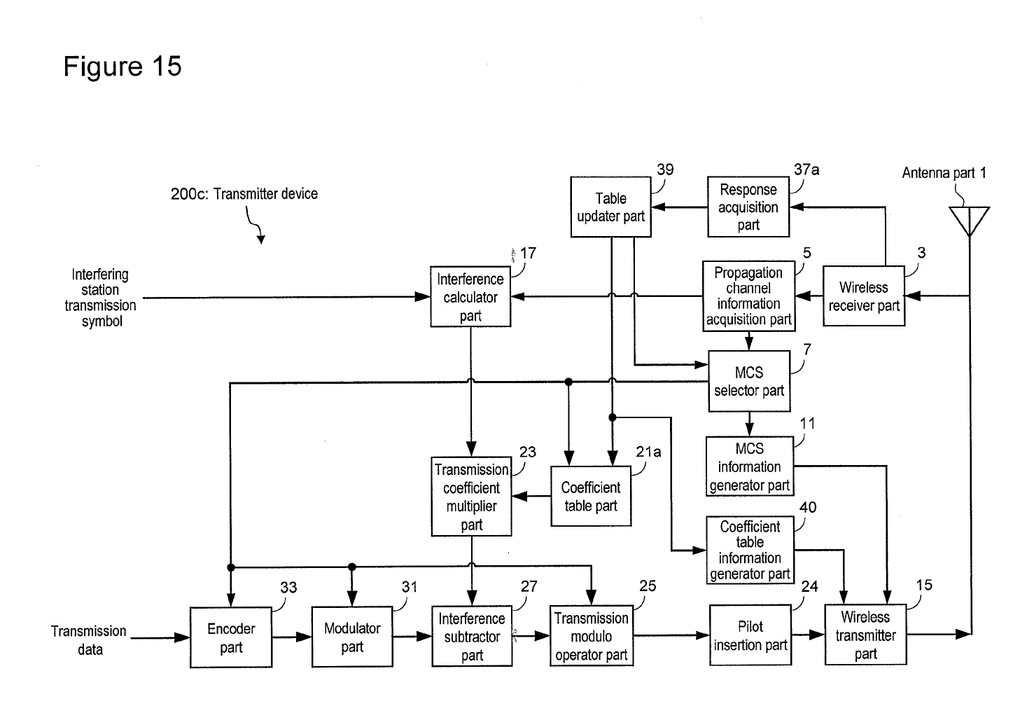

FIG. 15 is a functional block diagram showing a configuration example of a transmitter device 200c with respect to the fourth embodiment of the present invention. A description will be provided here only with respect to parts that differ from the transmitter device 200a in FIG. 8, while omitting descriptions for like parts.

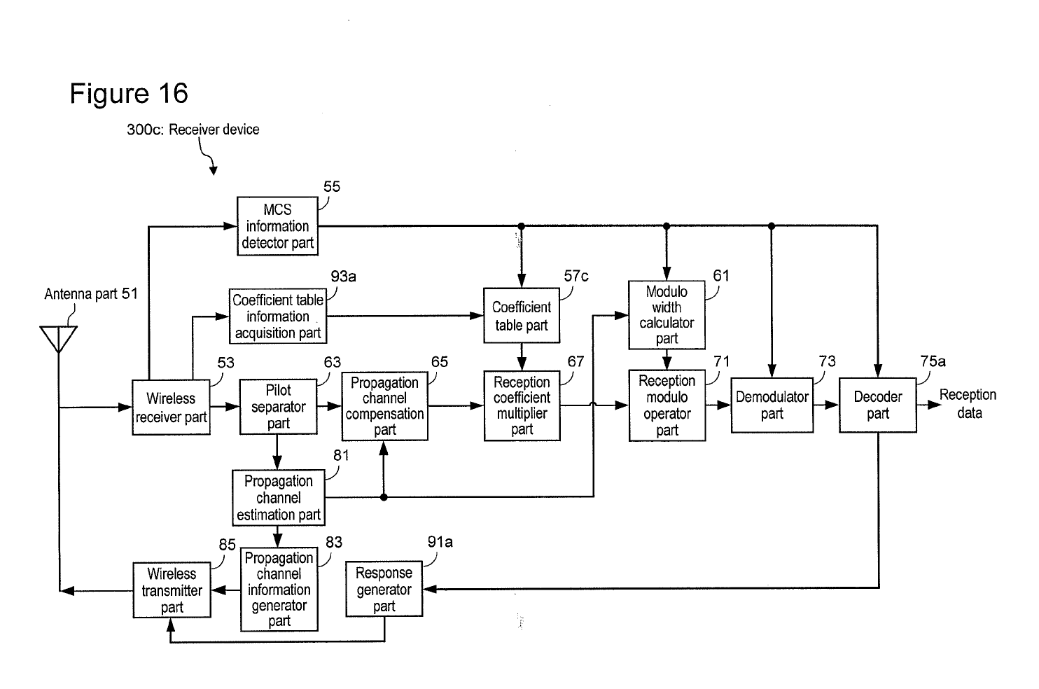

A response acquisition part 37a detects a positive response indicating the fact that reception has been carried out successfully (ACK: Acknowledgment) or a negative response indicating the fact that reception has not been carried out successfully (NACK: Negative Acknowledgment), which is notified from a receiver device 300c (FIG. 16) and contained in the signal received by the wireless receiver part 3 via the antenna part 1.

If the error rate of the reception data measured at the response acquisition part 37a is higher than the requisite error rate (many errors), or if it falls far below the requisite error rate (few errors), the table updater part 39 calculates coefficient α for each MCS and generates a new coefficient table. In addition, it may also concurrently alter the selection criteria for each MCS with respect to reception quality, and notify the MCS selector part 7.

The coefficient table part 21a replaces the coefficient table it holds with the coefficient table generated at the table updater part 39.

A coefficient table information generator part 40 generates coefficient table information for notifying the receiver device 300c of the coefficient table generated at the table updater part 39, and transmits it to the receiver device 300c via the wireless transmitter part 15.

FIG. 16 is a functional block diagram showing a configuration example of the receiver device 300c with respect to the fourth embodiment of the present invention. A description will be provided here only with respect to parts that differ from the receiver device 300a in FIG. 9, while omitting descriptions for like parts.

Based on the error examination result outputted by the decoder part 75a, a response generator part 91a generates a positive response if no error was detected, or a negative response if an error was detected, and notifies the transmitter device 200c via the wireless transmitter part 85.

A coefficient table information acquisition part 93a detects the coefficient table information notified from the transmitter device 200c, which is contained in the signal received by the wireless receiver part 53 via the antenna part 51. If coefficient table information is detected, the detected coefficient table information is outputted to a coefficient table part 57c.

Once coefficient table information is inputted, the coefficient table part 57c replaces the coefficient table it holds with the inputted coefficient table information.

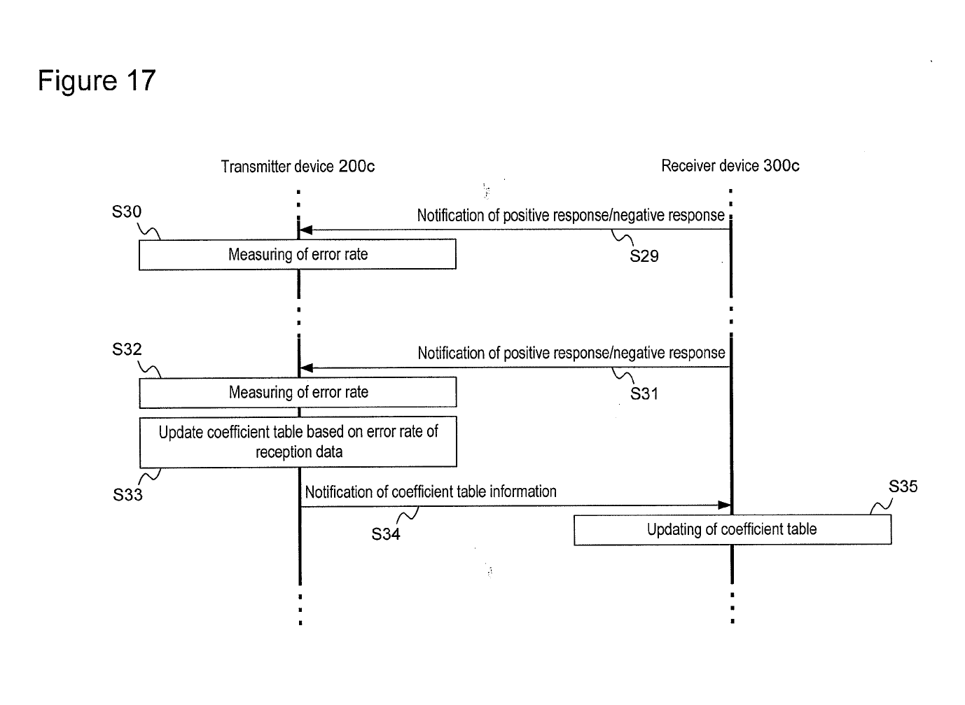

FIG. 17 is a flowchart showing an example of a communication procedure between the transmitter device 200c and the receiver device 300c of the present embodiment.

The procedure for data communication is omitted since it is similar to step S16 up to step S20 in FIG. 14.

The receiver device 300c generates a positive response if no error is detected in the reception data, or a negative response if an error is detected, and notifies the transmitter device 200c (step S29 and step S31).

The transmitter device 200c receives the positive response or the negative response, and measures the error rate (step S30 and step S32). If, based on the measured error rate, it is determined that the coefficient table needs to be updated, for example, if the error rate is higher than the requisite error rate, or if it falls far below the requisite error rate, it updates the coefficient table (step S33), and notifies the receiver device 300c of information of the updated coefficient table (step S34).

If coefficient table information is detected/received, the receiver device 300c replaces and updates the coefficient table held by the coefficient table part 57c with the received coefficient table information (step S35).

With the procedure above, it becomes possible for the transmitter device 200c of the present embodiment to sense, while communicating with the receiver device 300c and based on changes in the error rate of the reception data, the fact that coefficients α stored in the coefficient table for the respective MCS's have ceased to be optimal (due to such factors as changes in the reception environment, temperature changes, changes over time, etc.), update the coefficient table by recalculating coefficient α for each MCS, and share the updated coefficient table by notifying the receiver device 300c of the updated coefficient table. Thus, it is possible to always maintain the coefficient table in an appropriate state.

It is noted that, with respect to the present embodiment, a description has been provided for a case in which the error rate of the reception data is used as a reference for updating the coefficient table. However, the present invention is by no means limited as such. Instead, updates may be performed regularly with each passage of a given period of time, or irregularly.

In each of the embodiments above, a description has been provided by taking co-channel interference that a receiver device is subjected to from an interfering station device other than the transmitter device with which it is communicating as an example of the interference to be suppressed by applying ILP. However, interference that may be addressed is by no means limited as such.

By way of example, the present invention may also be applied to the suppression of multi-user interference in cases where transmission data from a transmitter device comprising a plurality of transmit antennas to a plurality of receiver devices is multicasted using multi-user MIMO (Multiple Input Multiple Output) techniques.

Further, the present invention may also be applied to the suppression of intersymbol interference caused by delay waves when a signal from the same transmitter device is received at a receiver device via a multi-path propagation channel.

Thus, with the features of the present embodiments, with respect to a wireless communication system employing ILP, it becomes possible to share coefficient α, which is used in common at a transmitter device and a receiver device in ILP, as uniquely mapped to the MCS, which is determined based on the SNR at the receiver device, and to determine coefficient α based solely on MCS information notified from the transmitter device to the receiver device.

Thus, it becomes unnecessary to add control information for notifying the receiver device of coefficient α from the transmitter device, and it is possible to prevent an increase in control information.

A communication device according to the present invention is applicable to portable terminals, such as portable radio devices, etc., and is also applicable to television functions that PCs, etc., are equipped with.

A program that runs on a communication device according to the present invention may be a program that controls a CPU (Central Processing Unit), etc., so as to realize the functions of the embodiments above relating to the present invention (a program that enables a computer to function). Further, the information handled by these devices is temporarily accumulated in RAM (Random Access Memory) during the processing thereof, is thereafter stored on various ROM (Read Only Memory), such as flash ROM, etc., or an HDD (Hard Disk Drive), and is read/modified/written by the CPU as required.

In addition, the processes of the various parts may be performed by recording on a computer-readable recording medium a program for realizing the functions of the various features in FIG. 1, etc., and having this program, which is recorded on the recording medium, read and executed by a computer system. It is noted that the term “computer system” as used herein is to encompass the OS, as well as hardware, such as peripheral devices, etc.

In addition, the term “computer-readable recording medium” may refer to a portable medium, such as a flexible disk, a magneto-optical disk, ROM, CD-ROM, etc., or a storage device such as a hard disk, etc., built into a computer system. Further, the term “computer-readable recording medium” is also to encompass one that dynamically holds a program for a short period of time, as in communication lines in a case where a program is transmitted over a network, such as the Internet, etc., or telecommunication lines, such as phone lines, etc., as well as one that holds a program for a given period of time, such as a volatile memory within a computer system that serves as a server or a client in such a case. In addition, the above-mentioned program may also be one for realizing a portion of the functions discussed above, and, further, it may also be one that is capable of realizing the functions discussed above in combination with a program(s) already recorded on a computer system. In addition, a portion, or the whole, of the communication devices of the embodiments discussed above may typically be realized as an LSI, which is an integrated circuit. The functional blocks of the communication devices may be individually implemented as chips, or they may be implemented as chips by integrating some or all of them. In addition, the method of circuit integration is not restricted to LSI, and may be realized through a dedicated circuit or a general purpose processor as well. In addition, should there emerge an alternative technique to LSI for circuit integration due to advances in semiconductor technology, an integrated circuit based on such a technique may also be used.

Although embodiments of the present invention have thus been described in detail with reference to the drawings, specific structures are not limited to those of the embodiments, and inventions with design modifications, etc., within a scope that does not depart from the spirit of the present invention are covered as well.

### INDUSTRIAL APPLICABILITY

The present invention is applicable to wireless communication devices.

All publications, patents and patent applications cited in the present specification are incorporated herein for reference in their entirety.

1. A wireless communication system in which, at a transmitter device, an interference signal component, which corresponds to an interference signal contained in a reception signal of a receiver device, is multiplied by a coefficient and subtracted from a desired signal, and a modulo operation is performed on a result of the subtraction which is then transmitted, wherein
the coefficient, which is used in common at the transmitter device and the receiver device, is uniquely mapped from a modulation parameter of the desired signal and shared between the transmitter device and the receiver device.

2. The wireless communication system according to claim 1, wherein mapping information, which uniquely maps the coefficient from modulation parameter information that notifies the modulation parameter of the desired signal, is shared between the transmitter device and the receiver device.

3. The wireless communication system according to claim 2, wherein the receiver device notifies the transmitter device of the mapping information prior to data communication.

4. The wireless communication system according to claim 2, wherein, at the receiver device, the unique mapping between the modulation parameter information and the coefficient within the mapping information is updated, and the transmitter device is notified of the updated mapping information.

5. The wireless communication system according to claim 4, wherein the updating of the mapping information is performed in accordance with a notification of an update request from the transmitter device.

6. The wireless communication system according to claim 2, wherein, at the transmitter device, the unique mapping between the modulation parameter information and the coefficient within the mapping information is updated, and the receiver device is notified of the updated mapping information.

7. The wireless communication system according to claim 4, wherein the updating of the mapping information is performed in accordance with an error rate of reception data.

8. A transmitter device in a wireless communication system in which, at the transmitter device, an interference signal component, which corresponds to an interference signal contained in a reception signal of a receiver device, is multiplied by a coefficient and subtracted from a desired signal, and a modulo operation is performed on a result of the subtraction which is then transmitted, wherein
the coefficient is determined in accordance with a modulation parameter of the desired signal addressed to the receiver device.

9. The transmitter device according to claim 8, wherein mapping information that uniquely maps the coefficient from the modulation parameter of the desired signal is shared with the receiver device.

10. The transmitter device according to claim 9, wherein the mapping information is received from the receiver device prior to data communication.

11. The transmitter device according to claim 9, wherein, when the unique mapping between the modulation parameter information and the coefficient within a mapping information is updated at the receiver device, the updated mapping information is received.

12. A transmitter device in a wireless communication system in which, at the transmitter device, an interference signal component, which corresponds to an interference signal contained in a reception signal of a receiver device, is multiplied by a coefficient and
mapping information storage part that holds combinations of respective modulation parameters and coefficients;
a modulation parameter selector part that selects a modulation parameter of the desired signal to be transmitted to the receiver device;
a transmission coefficient multiplier part that reads out from the mapping information storage part a coefficient mapped to the selected modulation parameter and multiplies the interference signal component, which corresponds to interference that the receiver device is subjected to, thereby;
an interference subtractor part that subtracts the interference signal component, as multiplied by the coefficient, from the desired signal to be transmitted to the receiver device, which is generated by applying the selected modulation parameter; and
a transmission modulo operator part that performs a modulo operation on a result of the subtraction.

13. The transmitter device according to claim 12, further comprising a modulation parameter information generator part that generates modulation parameter information for notifying the receiver device of the selected modulation parameter.

14. The transmitter device according to claim 12, further comprising a propagation channel information acquisition part that acquires channel quality information representing reception quality notified from the receiver device, wherein
the modulation parameter selector part selects the modulation parameter based on the channel quality information.

15. A receiver device in a wireless communication system in which, at a transmitter device, an interference signal component, which corresponds to an interference signal contained in a reception signal of the receiver device, is multiplied by a coefficient and subtracted from a desired signal, and a modulo operation is performed on a result of the subtraction which is then transmitted, wherein
the coefficient is identified based on a modulation parameter of the desired signal contained in the reception signal, the reception signal is multiplied by the coefficient, and a modulo operation is performed on a result of the multiplication.

16. The receiver device according to claim 15, wherein mapping information that uniquely maps the coefficient from the modulation parameter of the desired signal is shared with the transmitter device.

17. The receiver device according to claim 16, wherein the transmitter device is notified of the mapping information prior to data communication.

18. The receiver device according to claim 16, wherein the unique mapping between the modulation parameter information and the coefficient within the mapping information is updated, and the transmitter device is notified of the updated mapping information.

19. A receiver device in a wireless communication system in which, at a transmitter device, an interference signal component, which corresponds to an interference signal contained in a reception signal of the receiver device, is multiplied by a coefficient and subtracted from a desired signal, and a modulo operation is performed on a result of the subtraction which is then transmitted, the receiver device comprising:
a mapping information storage part that holds combinations of respective modulation parameters and coefficients;
a modulation parameter information detector part that acquires a modulation parameter of the desired signal in the reception signal;
a reception coefficient multiplier part that reads out from a coefficient table part a coefficient corresponding to the acquired modulation parameter and multiplies the reception signal thereby; and
a reception modulo operator part that performs a modulo operation on a result of the multiplication.

20. The receiver device according to claim 19, further comprising:
a propagation channel estimation part that estimates reception quality based on the reception signal or a pilot signal; and
a propagation channel information generator part that generates channel quality information representing, and for notifying the transmitter device of, a result of the reception quality estimation.

21. A communication method for a communication system in which coefficient α, which is used in common at a transmitter device and a receiver device, is uniquely mapped from a modulation parameter of a desired signal and shared between the transmitter device and the receiver device, the communication method comprising:
at the transmitter device, a step of multiplying an interference signal component, which corresponds to an interference signal contained in a reception signal of the receiver device, by the coefficient corresponding to the modulation parameter of the desired signal and subtracting it from the desired signal, and a step of performing a modulo operation on a result of the subtraction and of transmitting a transmission signal; and
at the receiver device, a step of receiving the transmission signal, multiplying it by the coefficient corresponding to the modulation parameter of the desired signal, and performing a modulo operation on a result of the multiplication.

22. A program for causing a computer to execute the method according to claim 21.
